(19) United States
(12) Patent Application Publication
(10) Pub. No.: US 2025/0242437 A1
(43) Pub. Date: Jul. 31, 2025

(54) LASER IRRADIATION APPARATUS

(71) Applicant: SEIKO EPSON CORPORATION, Tokyo (JP)

(72) Inventors: Yoshitomo KUMAI, OKAYA-SHI (JP); Yoji KITANO, CHINO-SHI (JP)

(73) Assignee: SEIKO EPSON CORPORATION, Tokyo (JP)

(21) Appl. No.: 19/023,424

(22) Filed: Jan. 16, 2025

(30) Foreign Application Priority Data
Jan. 26, 2024 (JP) 2024-010313

(51) Int. Cl. B23K 26/08; B23K 26/70; B23K 37/02; B23K 101/36

(52) U.S. Cl. CPC B23K 26/0869; B23K 26/703; B23K 37/0211; B23K 2101/36

(57) ABSTRACT

A laser irradiation apparatus includes a sub-mount including a first surface and a second surface opposite to the first surface, a laser element being provided to the first surface and configured to emit laser light, a heat radiation unit being provided to the second surface, and a moving mechanism configured to change a relative position of the laser element and an irradiation target object.

The present application is based on, and claims priority from JP Application Serial Number 2024-010313, filed Jan. 26, 2024, the disclosure of which is hereby incorporated by reference herein in its entirety.

### BACKGROUND

### 1. Technical Field

The present disclosure relates to a laser irradiation apparatus.

### 2. Related Art

There have been known a processing apparatus that processes a processing target object and a recording apparatus that performs recording such as printing on a recording target object through irradiation with laser light.

For example, JP-A-2021-154714 discloses a three-dimensional printer apparatus including a printer head configured to include a light-emitting array in which laser elements are arrayed, a liquid tank that houses a photosetting liquid that is cured with light emitted from the printer head, and a stage unit to which a mold formed through curing with light adheres.

In the above-mentioned laser irradiation apparatus that emits laser light, it is desired to improve heat dissipation.

### SUMMARY

A laser irradiation apparatus according to one aspect of the present disclosure includes a sub-mount including a first surface and a second surface opposite to the first surface, a laser element being provided to the first surface and configured to emit laser light, a heat radiation unit being provided to the second surface, and a moving mechanism configured to change a relative position of the laser element and an irradiation target object.

### BRIEF DESCRIPTION OF THE DRAWINGS

FIG. 1 is a perspective view schematically illustrating a laser irradiation apparatus according to a first embodiment.

FIG. 2 is a bottom view schematically illustrating the laser irradiation apparatus according to the first embodiment.

FIG. 3 is a cross-sectional view schematically illustrating the laser irradiation apparatus according to the first embodiment.

FIG. 4 is a cross-sectional view schematically illustrating a laser element of the laser irradiation apparatus according to the first embodiment.

FIG. 5 is a cross-sectional view schematically illustrating the laser irradiation apparatus according to the first embodiment.

FIG. 6 is a plan view schematically illustrating the laser irradiation apparatus according to the first embodiment.

FIG. 7 is a cross-sectional view schematically illustrating the laser irradiation apparatus according to the first embodiment.

FIG. 8 is a flowchart for describing a process of a control unit of the laser irradiation apparatus according to the first embodiment.

FIG. 9 is a perspective view schematically illustrating a laser irradiation apparatus according to a first modification example of the first embodiment.

FIG. 10 is a plan view schematically illustrating a laser irradiation apparatus according to a second modification example of the first embodiment.

FIG. 11 is a perspective view schematically illustrating a laser irradiation apparatus according to a second embodiment.

FIG. 12 is a cross-sectional view schematically illustrating the laser irradiation apparatus according to the second embodiment.

FIG. 13 is a flowchart for describing a process of a control unit of the laser irradiation apparatus according to the second embodiment.

FIG. 14 is a perspective view schematically illustrating a laser irradiation apparatus according to a modification example of the second embodiment.

### DESCRIPTION OF EMBODIMENTS

A preferred embodiment of the present disclosure is described in detail below with reference to the drawings. Note that the embodiments described below do not unduly limit the content of the present disclosure described in the claims. In addition, not all the configurations described below are essential constituent elements of the present disclosure.

### 1. First Embodiment

### 1.1. Laser Irradiation Apparatus

### 1.1.1. Configuration

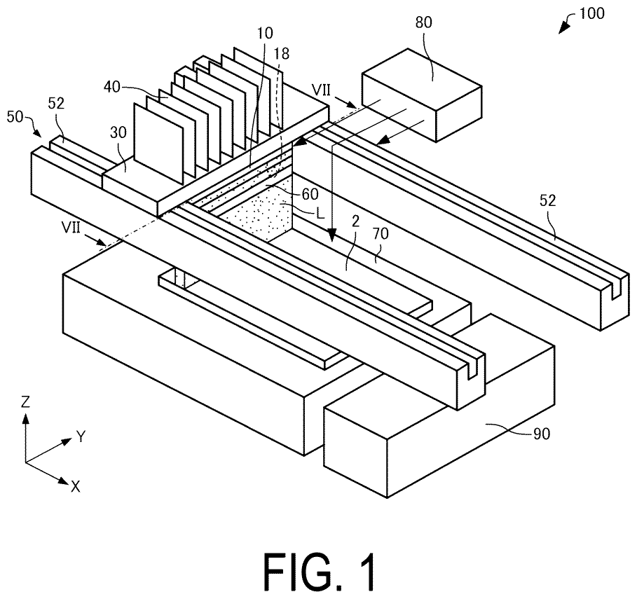

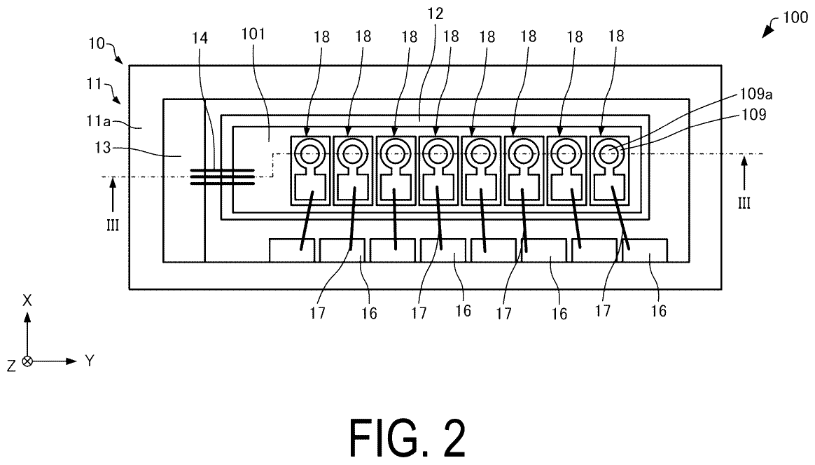

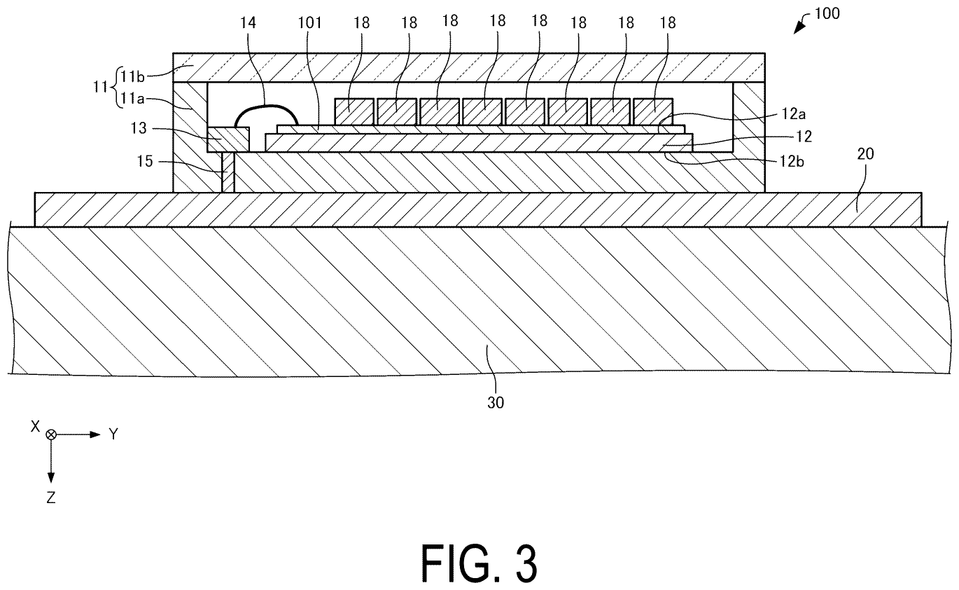

First, a laser irradiation apparatus according to a first embodiment is described with reference to the drawings. FIG. 1 is a perspective view schematically illustrating a laser irradiation apparatus 100 according to the first embodiment. FIG. 2 is a bottom view schematically illustrating the laser irradiation apparatus 100. FIG. 3 is a cross-sectional view taken along the line III-III of FIG. 2 schematically illustrating the laser irradiation apparatus 100.

Note that, for the sake of convenience, members other than a head 10 of the laser irradiation apparatus 100 are omitted in FIG. 2. Further, in FIG. 3, a laser element 18 of the laser irradiation apparatus 100 is illustrated in a simplified manner. Further, in FIG. 1 to FIG. 3, an X axis, a Y axis, and a Z axis are illustrated as three axes orthogonal to each other. For example, the X-axis direction and the Y-axis direction are horizontal directions. For example, the Z-axis direction is a vertical direction.

As illustrated in FIG. 1 to FIG. 3, for example, the laser irradiation apparatus 100 includes the head 10, a mount substrate 20, a support member 30, a heat radiation unit 40, a moving mechanism 50, an optical element 60, a stage 70, and a control unit 80. For example, the laser irradiation apparatus 100 is a laser processing apparatus. For example, the laser irradiation apparatus 100 is a metal 3D printer that uses the selective laser melting (SLM) method.

As illustrated in FIG. 2 and FIG. 3, for example, the head 10 includes a package 11, a sub-mount 12, a first pad 13, a first wire bonding 14, a via hole 15, a second pad 16, a second wire bonding 17, and the laser element 18.

As illustrated in FIG. 3, the package 11 accommodates the sub-mount 12, the first pad 13, the first wire bonding 14, the second pad 16, the second wire bonding 17, and the laser element 18.

For example, the package 11 includes a base portion 11a and a lid portion 11b. The base portion 11a is mounted at the mount substrate 20. For example, the material of the base portion 11a is a ceramic such as aluminum nitride and aluminum oxide. The lid portion 11b is coupled to the base portion 11a. The lid portion 11b transmits light from the laser element 18. For example, the material of the lid portion 11b is quartz, glass, or the like.

The sub-mount 12 is provided to the base portion 11a. For example, the shape of the sub-mount 12 is a plate-like shape. The sub-mount 12 includes a first surface 12a and a second surface 12b opposite to the first surface 12a. The first surface 12a and the second surface 12b are oriented in directions different from each other. In the example illustrated in the drawing, the first surface 12a is oriented in the −Z-axis direction. The second surface 12b is oriented in the +Z-axis direction. In the example illustrated in FIG. 2, the shape of the sub-mount 12 is a rectangular shape. For example, the sub-mount 12 has an insulating property. For example, the material of the sub-mount 12 is a ceramic such as aluminum nitride and aluminum oxide.

The first pad 13 is provided to the base portion 11a of the package 11. The first pad 13 is electrically coupled to the laser element 18 via the first wire bonding 14. For example, only one first pad 13 is provided. For example, the first pad 13 is electrically coupled to a driving circuit provided to the mount substrate 20, via the via hole 15.

The second pad 16 is provided to the base portion 11a of the package 11. The second pad 16 is electrically coupled to the laser element 18 via the second wire bonding 17. A plurality of the second pads 16 are provided corresponding to the plurality of laser elements 18. In the example illustrated in the drawing, the plurality of second pads 16 are arrayed in the Y-axis direction. For example, the second pad 16 is electrically coupled to the driving circuit provided to the mount substrate 20, via a via hole, which is omitted in illustration. The materials of the pads 13 and 16, the wire bondings 14 and 17, and the via hole 15 are copper, aluminum, gold, or the like.

The laser element 18 is provided to the first surface 12a of the sub-mount 12. In the example illustrated in the drawing, the laser element 18 contacts with the first surface 12a. For example, the laser element 18 emits laser light in the −Z-axis direction. For example, the laser element 18 is a photonic crystal surface emitting laser (PCSEL) using a photonic crystal effect. The laser light emitted from the laser element 18 being a PCSEL has a small radiation angle and a high light output. For example, a plurality of the laser elements 18 are provided. In the example illustrated in the drawing, eight laser elements 18 are provided. However, the number thereof is not particularly limited. For example, the plurality of laser elements 18 are arrayed in the Y-axis direction.

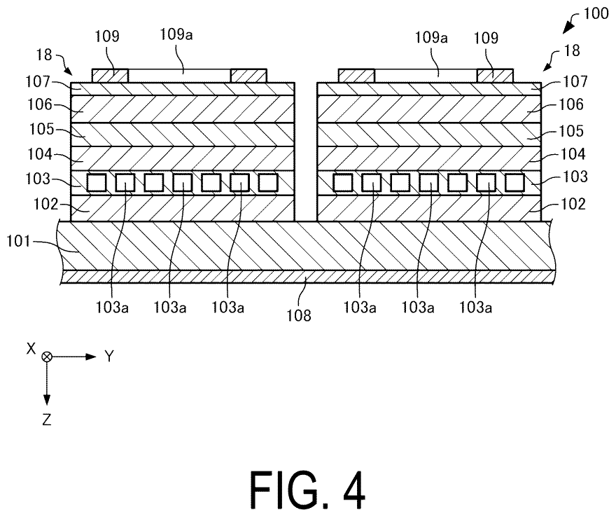

FIG. 4 is a cross-sectional view schematically illustrating the laser element 18. As illustrated in FIG. 4, for example, the laser element 18 includes a substrate 101, a first semiconductor layer 102, a first guide layer 103, a light-emitting layer 104, a second guide layer 105, a second semiconductor layer 106, a contact layer 107, a first electrode 108, a second electrode 109.

For example, the substrate 101 is an n-type semiconductor substrate doped with Si. The substrate 101 is provided continuously over the adjacent laser elements 18. The substrate 101 is provided integrally with the plurality of laser elements 18. The substrate 101 is a substrate commonly shared by the plurality of laser elements 18.

The first semiconductor layer 102 is provided to the substrate 101. The first semiconductor layer 102 is provided between the substrate 101 and the first guide layer 103. For example, the first semiconductor layer 102 is an n-type GaN layer doped with Si.

The first guide layer 103 is provided to the first semiconductor layer 102. The first guide layer 103 is provided between the first semiconductor layer 102 and the light-emitting layer 104. For example, the first guide layer 103 has a semiconductor superlattice (SL) structure formed of a GaN layer and an InGaN layer, which are an i-type and not intentionally doped with impurities. The numbers of the GaN layers and the InGaN layers forming the first guide layer 103 are not particularly limited.

In the first guide layer 103, an opening portion 103a is formed. For example, the opening portion 103a is a hole. For example, the planar shape of the opening portion 103a is a circle, a polygon, or the like. For example, the diameter of the opening portion 103a is 50 nm or more and 500 nm or less.

Note that “the diameter of the opening portion 103a” is a diameter when the planar shape of the opening portion 103a is a circle, and is a diameter of the minimum inclusion circle when the planar shape of the opening portion 103a is a shape other than the circle. For example, the diameter of the opening portion 103a is a diameter of a smallest circle that includes a polygon therein when the planar shape of the opening portion 103a is the polygon, and is a diameter of a smallest circle that includes an ellipse therein when the planar shape of the opening portion 103a is the ellipse.

A plurality of the opening portion 103a are provided. The plurality of opening portions 103a are separated from each other. For example, the interval between the adjacent opening portions 103a is 1 nm or more and 500 nm or less. In plan view, the plurality of opening portions 103a are arrayed in a predetermined pitch along a predetermined direction. For example, the plurality of opening portions 103a are arrayed in a regular triangular lattice pattern or a square lattice pattern. The plurality of opening portions 103a exhibit the photonic crystal effect.

Note that “the pitch of the opening portions 103a” is a distance between the centers of the opening portions 103a adjacent to each other along the predetermined direction. “The center of the opening portion 103a” indicates a center of a circle when the planar shape of the opening portion 103a is the circle, and is a center of the minimum inclusion circle when the planar shape of the opening portion 103a is a shape other than the circle. For example, the center of the opening portion 103a is a center of a smallest circle that includes a polygon therein when the planar shape of the opening portion 103a is the polygon, and is a center of a smallest circle that includes an ellipse therein when the planar shape of the opening portion 103a is the ellipse.

The light-emitting layer 104 is provided to the first guide layer 103. The light-emitting layer 104 is provided between the first guide layer 103 and the second guide layer 105. A current is injected to the light-emitting layer 104, and thus light is emitted. For example, the light-emitting layer 104 includes a well layer and a barrier layer. The well layer and the barrier layer are i-type semiconductor layers which are not doped with impurities intentionally. For example, the well layer is an InGaN layer. For example, the barrier layer is a GaN layer. the light-emitting layer 104 has a multiple quantum well (MQW) structure configured by the well layer and the barrier layer.

Note that the numbers of the well layers and the barrier layers forming the light-emitting layer 104 are not particularly limited. For example, only one well layer may be provided. In such a case, the light-emitting layer 104 has a single quantum well (SQW) structure.

The second guide layer 105 is provided at the light-emitting layer 104. The second guide layer 105 is provided between the light-emitting layer 104 and the second semiconductor layer 106. For example, the second guide layer 105 has an SL structure formed of a GaN layer and a InGaN layer, which are an i-type and not intentionally doped with impurities. The numbers of the GaN layers and the InGaN layers forming the second guide layer 105 are not particularly limited. The first guide layer 103 and the second guide layer 105 includes a function of increasing an optical confinement coefficient of the laser element 18.

Note that, although not illustrated, the plurality of opening portions 103a may not be formed in the first guide layer 103, and may be formed in the second guide layer 105. Alternatively, the opening portion 103a may be filled with a member having a refractive index lower than that of the first guide layer 103.

The second semiconductor layer 106 is provided to the second guide layer 105. The second semiconductor layer 106 is provided between the second guide layer 105 and the contact layer 107. For example, the second semiconductor layer 106 is a p-type GaN layer doped with Mg. The first semiconductor layer 102 and the second semiconductor layer 106 are cladding layers including a function of confining light in the light-emitting layer 104.

The contact layer 107 is provided to the second semiconductor layer 106. The contact layer 107 is provided between the second semiconductor layer 106 and the second electrode 109. For example, the contact layer 107 is a p-type GaN layer doped with Mg. The impurity concentration of the contact layer 107 is higher than the impurity concentration of the second semiconductor layer 106.

The first electrode 108 is provided in the +Z-axis direction with respect to the substrate 101. The substrate 101 may be in ohmic contact with the first electrode 108. The first electrode 108 is electrically coupled to the first semiconductor layer 102 via the substrate 101. The first electrode 108 is electrically coupled to the first pad 13 via the first wire bonding 14. The first electrode 108 is provided continuously over the adjacent laser elements 18. The first electrode 108 is provided integrally with the plurality of laser elements 18. The first electrode 108 is an electrode commonly shared by the plurality of laser elements 18. For example, the first electrode 108 is obtained by stacking a Ni layer and an Au layer in the stated order from the substrate 101 side. The first electrode 108 is one electrode for injecting a current to the light-emitting layer 104.

The second electrode 109 is provided to the contact layer 107. The contact layer 107 may be in ohmic contact with the second electrode 109. The second electrode 109 is electrically coupled to the second semiconductor layer 106 via the contact layer 107. The second electrode 109 is electrically coupled to the second pad 16 via the second wire bonding 17. For example, the second electrode 109 is obtained by stacking a Cr layer, a Ni layer, and an Au layer in the stated order from the contact layer 107 side. The second electrode 109 is the other electrode for injecting a current to the light-emitting layer 104.

In the second electrode 109, a through hole 109a is formed. The through hole 109a passes through the second electrode 109. Light generated in the light-emitting layer 104 passes through the through hole 109a, and is emitted. As viewed in the Z-axis direction, a region of the contact layer 107 that overlaps with the through hole 109a is a light-emitting region from which light generated in the light-emitting layer 104 is emitted.

In the laser element 18, a pin diode is configured by the second semiconductor layer 106 of a p-type, the light-emitting layer 104 and the guide layers 103 and 105 that are an i-type and not intentionally doped with impurities, and the first semiconductor layer 102 of an n-type. In the laser element 18, when a forward bias voltage of the pin diode is applied between the first electrode 108 and the second electrode 109 by a driving circuit, which is omitted in illustration, a current is injected to the light-emitting layer 104, and recombination of electrons and holes occurs in the light-emitting layer 104. This recombination causes light emission. The light generated in the light-emitting layer 104 propagates in a direction orthogonal to the Z-axis direction, forms a standing wave by the photonic crystal effect exhibited by the plurality of opening portions 103a, and receives a gain in the light-emitting layer 104. Thus, laser is oscillated. Further, the laser element 18 emits diffraction light as laser light in the Z-axis direction.

Note that, while the light-emitting layer 104 described above is InGaN based, the light-emitting layer 104 may be made of various materials capable of emitting light when an electric current is injected thereto, depending on the wavelength of light to be emitted. For example, semiconductor materials such as an AlGaN based, AlGaAs based, InGaAs based, InGaAsP based, InP based, GaP based, and AlGaP based materials may be used.

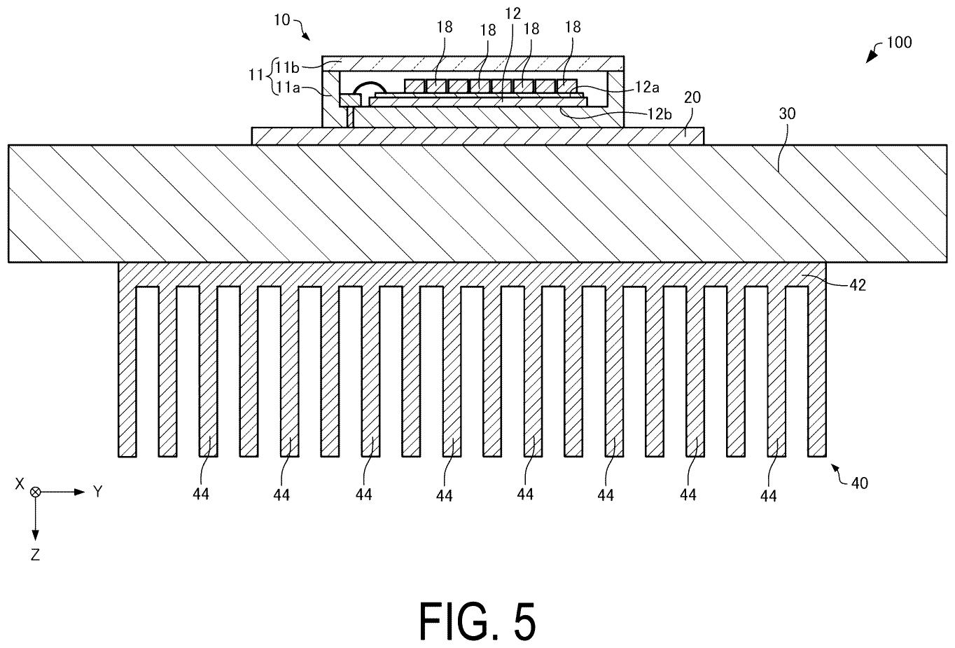

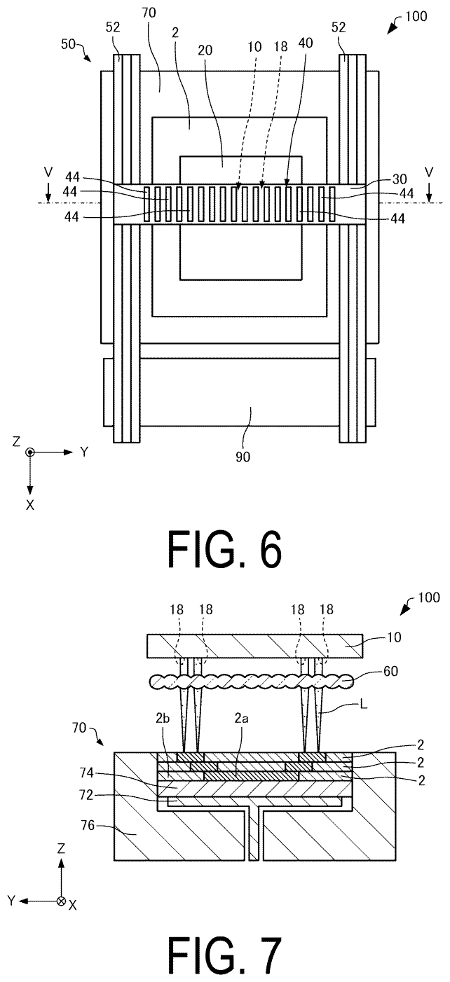

FIG. 5 is a cross-sectional view schematically illustrating the laser irradiation apparatus 100. FIG. 6 is a plan view schematically illustrating the laser irradiation apparatus 100. Note that FIG. 5 is a cross-sectional view taken along the line V-V of FIG. 6. Further, for the sake of convenience, members other than the head 10, the mount substrate 20, the support member 30, and the heat radiation unit 40 are omitted in FIG. 5.

As illustrated in FIG. 5 and FIG. 6, the mount substrate 20 supports the head 10. In the example illustrated in the drawing, the mount substrate 20 is provided in the +Z-axis direction with respect to the head 10. The mount substrate 20 is provided between the head 10 and the support member 30. For example, the mount substrate 20 is a ceramic substrate. The mount substrate 20 may be a silicon substrate. The mount substrate 20 may be provided with a driving circuit that drives the laser element 18.

The support member 30 supports the mount substrate 20. In the example illustrated in the drawing, the support member 30 is provided in the +Z-axis direction with respect to the mount substrate 20. The support member 30 is provided between the mount substrate 20 and the heat radiation unit 40. For example, the shape of the support member 30 is a plate-like shape. As illustrated in FIG. 6, the support member 30 is supported on two guide rails 52 of the moving mechanism 50. The support member 30 is provided over the two guide rails 52. For example, the material of the support member 30 is metal such as iron, aluminum and copper.

The heat radiation unit 40 is supported on the support member 30. In the example illustrated in the drawing, the heat radiation unit 40 is provided in the +Z-axis direction with respect to the support member 30. For example, the heat radiation unit 40 is provided to the second surface 12b of the sub-mount 12 via the support member 30, the mount substrate 20, and the base portion 11a of the package 11. In other words, the heat radiation unit 40 and the sub-mount 12 are thermally coupled to each other via the support member 30, the mount substrate 20, and the base portion 11a of the package 11. Thermal coupling indicates a state in which heat can be conducted between parts coupled to each other while they are directly coupled to each other or coupled to each other via a thermally conductive material. The heat radiation unit 40 radiates the heat generated at the laser element 18, via the sub-mount 12, the base portion 11a, the mount substrate 20, and the support member 30. For example, the heat radiation unit 40 has conductivity. For example, the heat conductivity of the heat radiation unit 40 is higher than the heat conductivity of the substrate 101, the heat conductivity of the sub-mount 12, and the heat conductivity of the mount substrate 20. The heat conductivity of the heat radiation unit 40 may be higher than the heat conductivity of the support member 30. For example, the material of the heat radiation unit 40 is metal such as copper.

As illustrated in FIG. 5, for example, the heat radiation unit 40 includes a plate-like portion 42 and a plurality of fins 44. The plate-like portion 42 is provided to the support member 30. The plate-like portion 42 is provided between the support member 30 and the plurality of fins 44. The fin 44 is provided to the plate-like portion 42. In the example illustrated in the drawing, the fin 44 protrudes in the +Z-axis direction from the plate-like portion 42. For example, the fin 44 is provided integrally with the plate-like portion 42. For example, the plurality of fins 44 are arrayed in the Y-axis direction. As illustrated in FIG. 6, as viewed in the Z-axis direction, the fin 44 extends in the X-axis direction.

For example, the moving mechanism 50 includes the guide rails 52 and a motor, which is omitted in illustration. For example, the two guide rails 52 are provided. The two guide rails 52 are arrayed in the Y-axis direction. The sub-mount 12 is supported on the two guide rails 52 via the base portion 11a of the package 11, the mount substrate 20, and the support member 30. The two guide rails 52 do not overlap with the irradiation target object 2 in plan view. The two guide rails 52 do not overlap with the head 10 in plan view. In other words, the two guide rails 52 do not overlap with the laser element 18 in plan view.

The moving mechanism 50 changes the relative position of the laser element 18 and the irradiation target object 2 by a motor, which is omitted in illustration. The motor is controlled by the control unit 80. In the example illustrated in the drawing, the moving mechanism 50 moves the laser element 18 in the +X-axis direction. The moving mechanism 50 moves the head 10, the mount substrate 20, the support member 30, and the heat radiation unit 40 in the +X-axis direction. For example, the guide rail 52 extends in the X-axis direction. The moving mechanism 50 moves the laser element 18 along the guide rail 52. The moving mechanism 50 may further include an encoder, which is omitted in illustration. The moving mechanism 50 does not move the irradiation target object 2.

FIG. 7 is a cross-sectional view taken along the line VII-VII of FIG. 1 schematically illustrating the laser irradiation apparatus 100. Note that, for the sake of convenience, the head 10 is illustrated in FIG. 7 in a simplified manner. Further, the mount substrate 20, the support member 30, the heat radiation unit 40, and the moving mechanism 50 are omitted in FIG. 7.

As illustrated in FIG. 7, the laser light L emitted from the laser element 18 enters the optical element 60. The optical element 60 is provided between the head 10 and the irradiation target object 2. Although not illustrated, the optical element 60 may be supported on the guide rail 52. For example, the optical element 60 focuses the laser light L from the laser element 18. For example, the optical element 60 is a lens array. The focal point of the lens configuring the optical element 60 may be located on the irradiation target object 2. In this manner, an irradiation time of the irradiation target object 2 can be reduced. For example, a plurality of the lenses configuring the optical element 60 are provided in accordance with the number of the laser elements 18.

The irradiation target object 2 is supplied and placed on the stage 70. The irradiation target object 2 is provided between the head 10 and the stage 70. For example, the irradiation target object 2 is a process target object to be processed with the laser light L from the laser element 18. For example, the irradiation target object 2 is metal powder that can be melted with the laser light L. The irradiation target object 2 is supplied by a supplying machine, which is omitted in illustration.

For example, the stage 70 includes a stage base 72, an elevator mechanism 74, and a housing 76 that accommodates the stage base 72 and the elevator mechanism 74.

The irradiation target object 2 is supplied to the stage base 72 by a supplying machine, which is omitted in illustration. The head 10 irradiates the irradiation target object 2 on the stage base 72 with the laser light L to form a molten portion 2a and a non-molten portion 2b in the irradiation target object 2. After molten through irradiation with the laser light L, the molten portion 2a is cooled and solidified. The non-molten portion 2b is not irradiated with the laser light L. Therefore, the non-molten portion 2b is not solidified and remains as metal powder.

The elevator mechanism 74 supports the stage base 72. In the example illustrated in the drawing, the elevator mechanism 74 moves the stage base 72 in the −Z-axis direction. As the stage base 72 moves, the irradiation target object 2 moves. After the stage base 72 moves in the −Z-axis direction, the supplying machine again supplies the irradiation target object 2 of the second layer. The irradiation target object 2 of the second layer is supplied on the irradiation target object 2 of the first layer. Then, the head 10 irradiates the irradiation target object 2 of the second layer with the laser light L.

As described above, a laminate body formed of a plurality of layers of the irradiation target object 2 can be formed by repeating the series of steps of the supply of the irradiation target object 2 by the supplying machine, the irradiation with the laser light L by the head 10, and the movement of the stage base 72 by the elevator mechanism 74. Further, the non-molten portion 2b in the lamination body is removed by a removal apparatus, which is omitted in illustration. With this, a three-dimensional object having a predetermined shape is shaped. Examples of the removal apparatus include an air blow and a brush.

For example, the control unit 80 is configured by a computer including a processor, a main storage device, and an input/output interface that inputs and outputs a signal with external parts. For example, the control unit 80 implements various functions with the processor executing a program read in the main storage device, for example. Specifically, the control unit 80 controls the laser element 18, the moving mechanism 50, and the elevator mechanism 74. Note that the control unit 80 may be configured by a combination of a plurality of circuits instead of a computer.

Note that, as illustrated in FIG. 1, the laser irradiation apparatus 100 may include a calibration device 90. The calibration device 90 may include a photodetector that receives the laser light L. In a case in which the calibration device 90 is provided, even when the characteristics of the laser element 18 are deviated from a design value, the calibration device 90 can detect the deviation and feedback the deviation to a processing process.

### 1.1.2. Operation

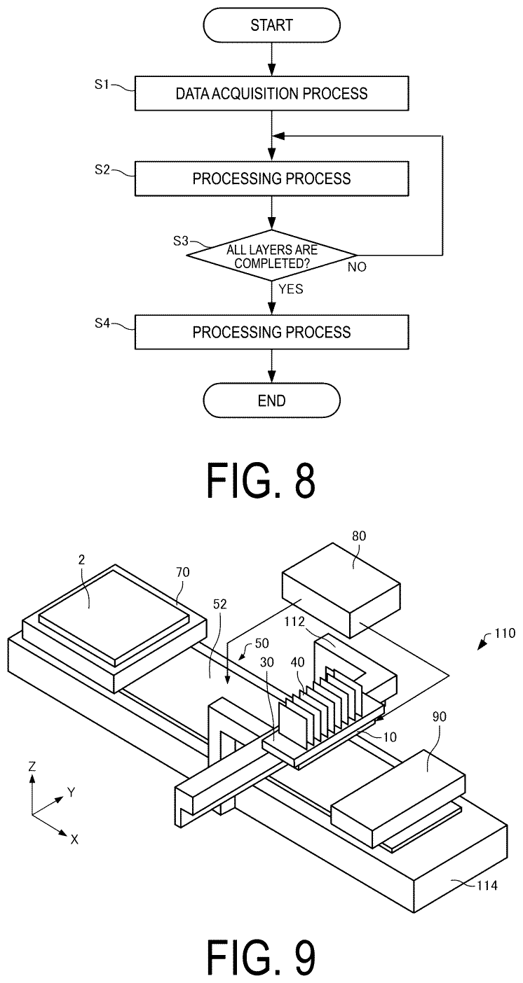

Next, an operation of the laser irradiation apparatus 100 according to the first embodiment is described with reference to the drawings. Specifically, a process of the control unit 80 of the laser irradiation apparatus 100 according to the first embodiment is described with reference to the drawings. FIG. 8 is a flowchart for describing a process of the control unit 80.

For example, a user operates an operation unit, which is omitted in illustration, to output a process start signal for starting a process to the control unit 80. For example, the operation unit is configured by a mouse, a keyboard, a touch panel, or the like. When the control unit 80 receives the process start signal, it starts the process.

First, as illustrated in FIG. 8, the control unit 80 executes a data acquisition process that acquires shaping data for shaping a three-dimensional object (Step S1).

For example, the shaping data includes information relating to the material of the metal powder forming the irradiation target object 2, the number of layers of the irradiation target object 2, the movement speed of the head 10, on/off of the plurality of laser elements 18, and the like.

For example, the shaping data is created by reading shaping data into slicer software installed in a computer coupled to the laser irradiation apparatus 100. The shaping data is data representing an intended shape of a three-dimensional object created by using three-dimensional computer aided design (CAD) software, three-dimensional computer graphics (CG) software and/or the like. For example, as the shaping data, data of the standard triangulated language (STL) format and/or the additive manufacturing file format (AMF) is used. The slicer software divides the intended shape of the three-dimensional object into layers with a predetermined thickness and creates the shaping data for each layer. The shaping data is represented by G codes, M codes, and the like. The control unit 80 acquires the shaping data from a computer coupled to the laser irradiation apparatus 100 or a recording medium such as a universal serial bus (USB) memory.

Subsequently, the control unit 80 controls the laser element 18 and the moving mechanism 50 to execute the processing process of changing the relative position of the laser element 18 and the irradiation target object 2 while irradiating the irradiation target object 2 with the laser light L (Step S12).

Specifically, the control unit 80 causes the laser element 18 to emit the laser light L, based on the shaping data. At the same time, the control unit 80 drives the motor of the moving mechanism 50 to move the laser element 18 in the +X-axis direction. In this manner, the irradiation target object 2 can be processed. As illustrated in FIG. 7, the molten portion 2a and the non-molten portion 2b are formed in the irradiation target object 2.

Subsequently, as illustrated in FIG. 8, the control unit 80 executes a determination process of determining whether formation of all the layers of the irradiation target object 2 is completed, based on the shaping data (Step S3).

When it is determined that formation of all the layers of the irradiation target object 2 is not completed (“NO” in Step S3), the control unit 80 returns the process to Step S2. The control unit 80 repeats Step S2 and Step S3 until it is determined that formation of all the layers of the irradiation target object 2 is completed in Step S3.

In contrast, when the control unit 80 determines that formation of all the layers of the irradiation target object 2 is completed (“YES” in Step S3), the control unit 80 executes a non-molten portion removal process of causing the removal apparatus to remove the non-molten portion 2b in the lamination body formed of the irradiation target object 2 (Step S4). In this manner, a three-dimensional object is shaped. Further, the control unit 80 terminates the process.

Note that a user may manually remove the non-molten portion 2b. In this case, after determining that formation of all the layers of the irradiation target object 2 is completed, the control unit 80 terminates the process.

### 1.1.3. Actions and Effects

The laser irradiation apparatus 100 includes the sub-mount 12 that includes the first surface 12a and the second surface 12b opposite to the first surface 12a, the laser element 18 that is provided to the first surface 12a and emits the laser light L, the heat radiation unit 40 that is provided to the second surface 12b, and the moving mechanism 50 that changes the relative position of the laser element 18 and the irradiation target object 2.

Thus, in the laser irradiation apparatus 100, the heat of the laser element 18 can be radiated from the heat radiation unit 40 via the sub-mount 12. Therefore, heat dissipation can be improved. Thus, output fluctuations of the laser element 18 due to heat can be reduced. As a result, an operation of the laser element 18 can be stabilized.

In the laser irradiation apparatus 100, the sub-mount 12 has an insulating property. Thus, in the laser irradiation apparatus 100, it is possible to prevent a current from arriving at the heat radiation unit 40 via the sub-mount 12.

In the laser irradiation apparatus 100, the heat radiation unit 40 has conductivity. Thus, the heat radiation unit 40 can have high heat conductivity.

In the laser irradiation apparatus 100, the moving mechanism 50 includes the two guide rails 52, and the sub-mount 12 is supported on the two guide rails 52. Thus, the sub-mount 12 can be supported more stably in the laser irradiation apparatus 100 as compared to a case in which the sub-mount is supported on one guide rail.

In the laser irradiation apparatus 100, the two guide rails 52 do not overlap with the laser element 18 in plan view. Thus, in the laser irradiation apparatus 100, the heat of the laser element 18 can be radiated efficiently from the heat radiation unit 40.

In the laser irradiation apparatus 100, the heat radiation unit 40 includes the plurality of fins 44. Thus, in the laser irradiation apparatus 100, the heat of the laser element 18 can be radiated from the plurality of fins 44.

In the laser irradiation apparatus 100, the moving mechanism 50 moves the laser element 18 in the X-axis direction being a first direction. In plan view, each of the plurality of fins 44 extends in the X-axis direction. Thus, in the laser irradiation apparatus 100, the air resistance experienced by the fin 44 can be reduced. In this manner, the laser element 18 can smoothly move.

In the laser irradiation apparatus 100, the irradiation target object 2 is a process target object to be processed with the laser light L from the laser element 18. In the laser irradiation apparatus 100, the irradiation target object 2 is a process target object to be processed with the laser light L from the laser element 18.

In the laser irradiation apparatus 100, the laser element 18 is a PCSEL. Thus, in the laser irradiation apparatus 100 the radiation angle of the laser light L from the laser element 18 can be narrowed. In this manner, an irradiation time of the irradiation target object 2 can be reduced.

### 1.2. Modification Examples of Laser Irradiation Apparatus

### 1.2.1. First Modification Example

Next, a laser irradiation apparatus according to a first modification example of the first embodiment is described with reference to the drawings. FIG. 9 is a cross-sectional view schematically illustrating a laser irradiation apparatus 110 according to the first modification example of the first embodiment.

Hereinafter, in the laser irradiation apparatus 110 according to the first modification example of the first embodiment, members thereof having similar functions to the constituent members of the laser irradiation apparatus 100 according to the first embodiment described above are denoted with the same reference symbols, and the detailed description thereof is omitted. The same applies to a laser irradiation apparatus according to a second modification example of the first embodiment, which is described later.

In the laser irradiation apparatus 100 described above, as illustrated in FIG. 1, the head 10 is moved in the +X-axis direction in the processing process.

In contrast, as illustrated in FIG. 9, in the laser irradiation apparatus 110, the head 10 is fixed to a fixing unit 112. For example, the laser irradiation apparatus 110 includes the fixing unit 112 and a base table 114.

The fixing unit 112 is provided across the rail 52 of the movement mechanism 50. In the processing process, the head 10 does not move. The head 10 is separated from the movement mechanism 50, and is positioned above the movement mechanism 50. Only one guide rail 52 is provided.

The base table 114 supports the guide rail 52. The guide rail 52 is provided on the base table 114. The stage 70 is provided on the guide rail 52. In the processing process, the control unit 80 controls the movement mechanism 50 to move the stage 70 in the +X-axis direction. As the stage 70 moves, the irradiation target object 2 moves in the +X-axis direction. In this manner, the relative position of the laser element 18 and the irradiation target object 2 is changed.

### 1.2.2. Second Modification Example

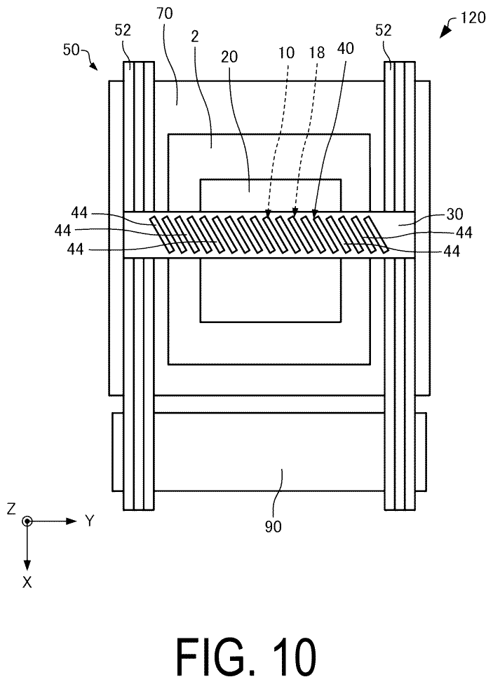

Next, the laser irradiation apparatus according to the second modification example of the first embodiment is described with reference to the drawings. FIG. 10 is a plan view schematically illustrating a laser irradiation apparatus 120 according to a second modification example of the first embodiment.

In the laser irradiation apparatus 100 described above, as illustrated in FIG. 6, as viewed in the Z-axis direction, the fin 44 extends in the X-axis direction.

In contrast, as illustrated in FIG. 10, in the laser irradiation apparatus 120, as viewed in the Z-axis direction, the fin 44 extends in a direction inclined with respect to the X-axis direction. In other words, as viewed in the Z-axis direction, the fin 44 does not extend in the X-axis direction, and does not extend in a direction orthogonal to the X-axis direction. The fin 44 extends in a direction inclined with respect to the X-axis direction and the Y-axis direction. In the example illustrated in the drawing, the fin 44 extends in a direction inclined by 30 degrees with respect to the X-axis direction. Note that the extension direction of the fin 44 is not particularly limited as long as it is inclined with respect to the X-axis direction.

In the laser irradiation apparatus 120, the moving mechanism 50 moves the laser element 18 in the X-axis direction being a first direction. In plan view, each of the plurality of fins 44 extends in a second direction inclined with respect to the X-axis direction. Thus, in the laser irradiation apparatus 120, the amount of air that hits the fin 44 can be increased. In this manner, heat dissipation can be improved. Note that, although not illustrated, a cooling fan for cooling the heat radiation unit 40 may be provided in the −X-axis direction with respect to the heat radiation unit 40. The cooling fan may blow air in the +X-axis direction.

### 2. Second Embodiment

### 2.1. Laser Irradiation Apparatus

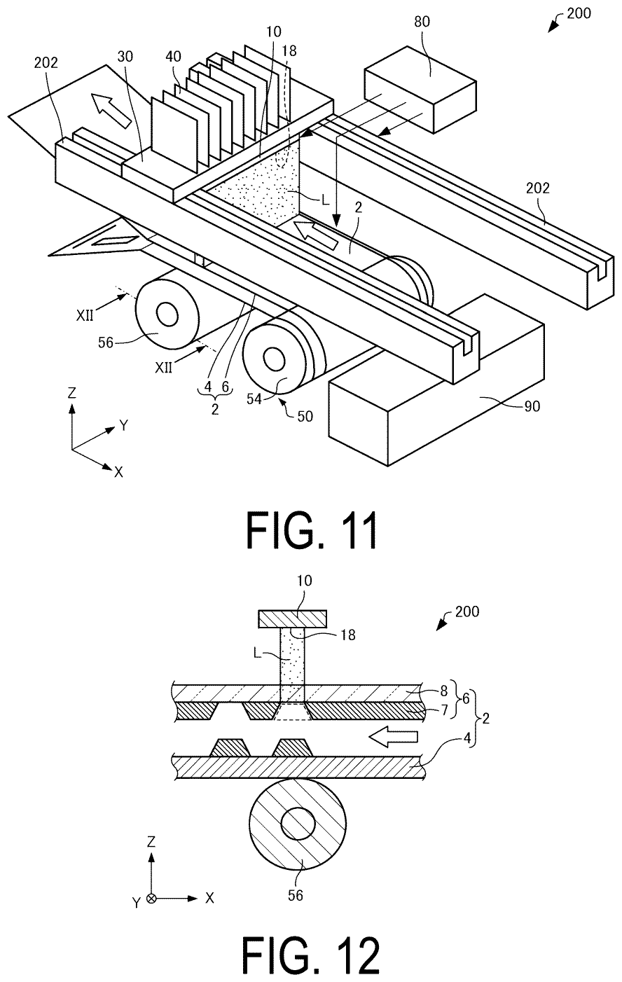

Next, a laser irradiation apparatus according to a second embodiment is described with reference to the drawings. FIG. 11 is a perspective view schematically illustrating a laser irradiation apparatus 200 according to the second embodiment. FIG. 12 is a cross-sectional view taken along the line XII-XII of FIG. 11 schematically illustrating the laser irradiation apparatus 200 according to the second embodiment. Note that, for the sake of convenience, the head 10 is illustrated in FIG. 12 in a simplified manner. Further, the mount substrate 20, the support member 30, and the heat radiation unit 40 are omitted in FIG. 12.

Hereinafter, in the laser irradiation apparatus 200 according to the second embodiment, members thereof having similar functions to the constituent members of the laser irradiation apparatus 100 according to the first embodiment described above are denoted with the same reference symbols, and the detailed description thereof is omitted.

In the laser irradiation apparatus 100 described above, as illustrated in FIG. 1 and FIG. 7, the irradiation target object 2 is a process target object to be processed with the laser light L from the laser element 18.

In contrast, as illustrated in FIG. 11 and FIG. 12, in the laser irradiation apparatus 200, the irradiation target object 2 is a recording target object on which recording is performed with the laser light L from the laser element 18. The laser irradiation apparatus 200 is a recording apparatus.

For example, the laser irradiation apparatus 200 includes support rods 202. For example, two support rods 202 are provided. In the example illustrated in the drawing, the two support rods 202 are arrayed in the Y-axis direction. The support rod 202 has a shape extending in the X-axis direction. The head 10 is supported on the support rod 202 via the support member 30.

The moving mechanism 50 is separated from the support member 30. The moving mechanism 50 is positioned in the −Z-axis direction with respect to the head 10. For example, the moving mechanism 50 includes a transport unit 54 and a support unit 56.

The transport unit 54 transports the irradiation target object 2 to the support unit 56. In the example illustrated in the drawing, the transport unit 54 transports the irradiation target object 2 in the −X-axis direction. The irradiation target object 2 is wound about the transport unit 54. For example, the transport unit 54 is a roller that supplies the irradiation target object 2 to the support unit 56. For example, the shape of the irradiation target object 2 is a sheet-like shape.

For example, the support unit 56 is provided in the −X-axis direction with respect to the transport unit 54. When recording is performed on the irradiation target object 2, the support unit 56 supports the irradiation target object 2 transported from the transport unit 54. For example, the support unit 56 is a platen roller. In the example illustrated in the drawing, the transport unit 54 and the support unit 56 rotate about the Y axis. For example, rotation of the transport unit 54 and the support unit 56 is controlled by the control unit 80. When the transport unit 54 and the support unit 56 rotate, the moving mechanism 50 moves the irradiation target object 2 in the −X-axis direction.

In the recording process for the irradiation target object 2, the irradiation target object 2 is positioned between the head 10 and the support unit 56. For example, the irradiation target object 2 includes a recording sheet 4 and an ink ribbon 6 provided above the recording sheet 4. As illustrated in FIG. 12, for example, the ink ribbon 6 includes an ink layer 7 formed of thermo-meltable ink and a base 8 provided on the ink layer 7. For example, the base 8 is transparent. At the time of irradiation with the laser light L from the head 10, the ink layer 7 in the irradiated part is melted and transferred onto the recording sheet 4. In this manner, recording such as printing can be performed on the recording sheet 4. For example, the laser irradiation apparatus 200 is a thermal printer of a thermal transfer type. Note that, for the sake of convenience of the description, in FIG. 12, the recording sheet 4 and the ink ribbon 6 are away from each other. In general, the recording sheet 4 and the ink ribbon 6 contact with each other.

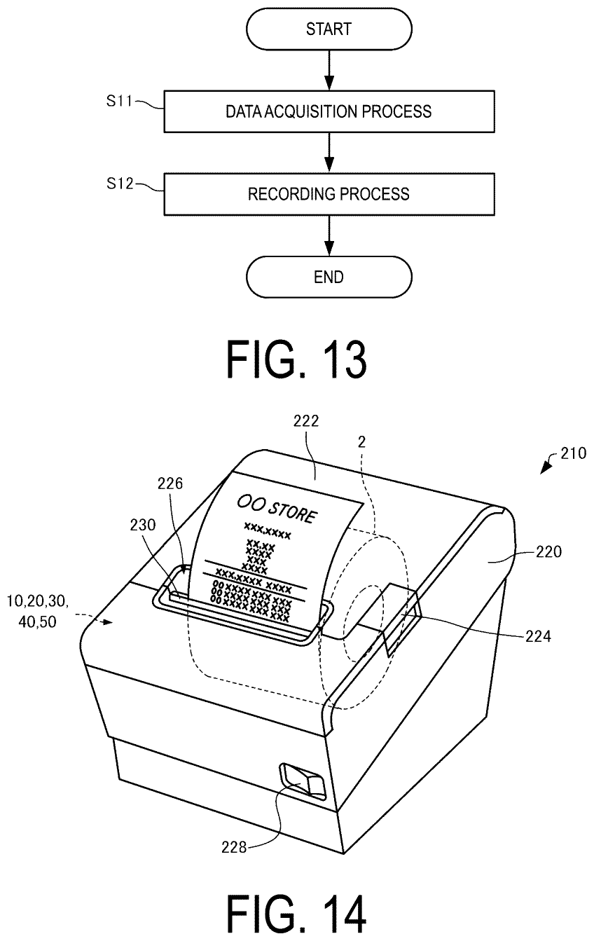

Herein, FIG. 13 is a flowchart for describing a process of the control unit 80 of the laser irradiation apparatus 200. For example, a user operates an operation unit, which is omitted in illustration, to output a process start signal for starting a process to the control unit 80. When the control unit 80 receives the process start signal, it starts the process.

First, as illustrated in FIG. 13, the control unit 80 executes a data acquisition process of acquiring printing data generated by a user (Step S11).

Subsequently, the control unit 80 controls the laser element 18 and the moving mechanism 50 to execute the recording process of changing the relative position of the laser element 18 and the irradiation target object 2 while irradiating the irradiation target object 2 with the laser light L (Step S12).

Specifically, the control unit 80 causes the laser element 18 to emit the laser light L, based on the printing data. At the same time, the control unit 80 drives the transport unit 54 of the moving mechanism 50 to move the irradiation target object 2 in the −X-axis direction. In this manner, recording can be formed on the irradiation target object 2.

Further, the control unit 80 terminates the process.

In the laser irradiation apparatus 200, the irradiation target object 2 is a recording target object on which recording is performed with the laser light L from the laser element 18. Thus, in the laser irradiation apparatus 200, recording can be performed accurately on the irradiation target object 2.

### 2.2. Modification Example of Laser Irradiation Apparatus

Next, a laser irradiation apparatus according to a modification example of the second embodiment is described with reference to the drawings. FIG. 14 is a perspective view schematically illustrating a laser irradiation apparatus 210 according to the modification example of the second embodiment.

Hereinafter, in the laser irradiation apparatus 210 according to the modification example of the second embodiment, members thereof having similar functions to the constituent members of the laser irradiation apparatus 200 according to the second embodiment described above are denoted with the same reference symbols, and the detailed description thereof is omitted.

The laser irradiation apparatus 210 is a receipt printer, which is different from the laser irradiation apparatus 200 described above. For example, the laser irradiation apparatus 210 is provided to a register counter at a store such as a supermarket, a convenience store, and a restaurant. Further, the laser irradiation apparatus 210 issues a receipt as a result of printing an image on the irradiation target object 2 according to a transaction conducted at the register counter. For example, the material of the irradiation target object 2 is paper. Note that the material of the irradiation target object 2 may be polyethylene (PE), polyethylene terephthalate (PET), or polypropylene (PP).

As illustrated in FIG. 14, for example, the laser irradiation apparatus 210 includes an accommodation unit 220 and a cutter 230.

The accommodation unit 220 accommodates the irradiation target object 2 wound in a roll-like shape, the head 10, the mount substrate 20, the support member 30, the heat radiation unit 40, the moving mechanism 50, and the cutter 230. The accommodation unit 220 includes an openable/closable cover 222. When a user presses down a lever 224, the cover 222 is in an open state. A user can replenish or replace the irradiation target object 2 wound in a roll-like shape while the cover 222 opens. In the cover 222, a discharge slot 226 through which the irradiation target object 2 after printing is discharged is provided. Further, the accommodation unit 220 is provided with a power switch 228 for switching the power of the laser irradiation apparatus 210 between an on state and an off state.

The cutter 230 is provided at a position corresponding to the discharge slot 226. The cutter 230 cuts the irradiation target object 2 on which printing is performed. In this manner, a receipt is generated. The shape of the cutter 230 is not particularly limited as long as it can cut the irradiation target object 2.

Note that the applications of the laser irradiation apparatus according to the present disclosure are not particularly limited, and may include, for example, a laser cleaner for removing rust and the like from metal using laser light or a laser annealing apparatus for heating a surface of metal or a resin with laser light.

Further, the material of the irradiation target object is not particularly limited, and may be, for example, a resin such as a photo-curable resin, a wood material, glass, paper, leather, minerals, and the like.

The embodiments and the modification examples described above are merely examples, and are not intended as limiting. For example, each embodiment and each modification example can also be combined together as appropriate.

The present disclosure includes configurations that are substantially identical to the configurations described in the embodiments, for example, configurations with identical functions, methods and results, or with identical advantages and effects. Also, the present disclosure includes configurations obtained by replacing non-essential portions of the configurations described in the embodiments. In addition, the present disclosure also includes configurations that achieve the same effects as the configurations described in the embodiments or configurations that can achieve the same advantages. Further, the present disclosure includes configurations obtained by adding known techniques to the configurations described in the embodiments.

The following contents are derived from the embodiments and the modification examples described above.

A laser irradiation apparatus according to one aspect includes a sub-mount including a first surface and a second surface opposite to the first surface, a laser element being provided to the first surface and configured to emit laser light, a heat radiation unit being provided to the second surface, and a moving mechanism configured to change a relative position of the laser element and an irradiation target object.

According to the laser irradiation apparatus, heat dissipation can be improved.

In the laser irradiation apparatus according to the one aspect, the sub-mount may have an insulating property.

According to the laser irradiation apparatus, a current can be prevented from reaching the heat radiation unit via the sub-mount.

In the laser irradiation apparatus according to the one aspect, the heat radiation unit may have conductivity.

According to the laser irradiation apparatus, the heat radiation unit can have high heat conductivity.

In the laser irradiation apparatus according to the one aspect, the moving mechanism may include two guide rails, and the sub-mount may be supported on the two guide rails.

According to the laser irradiation apparatus, the sub-mount can be stably supported.

In the laser irradiation apparatus according to the one aspect, the two guide rails may not overlap with the laser element in plan view.

According to the laser irradiation apparatus, heat of the laser element can be radiated efficiently from the heat radiation unit.

In the laser irradiation apparatus according to the one aspect, the heat radiation unit may include a plurality of fins.

According to the laser irradiation apparatus, heat of the laser element can be radiated from the plurality of fins.

In the laser irradiation apparatus according to the one aspect, the moving mechanism may move the laser element in a first direction, and each of the plurality of fins may extend in the first direction in plan view.

According to the laser irradiation apparatus, the air resistance experienced by the fin can be reduced.

In the laser irradiation apparatus according to the one aspect, the moving mechanism may move the laser element in a first direction, and each of the plurality of fins may extend in a second direction inclined with respect to the first direction in plan view.

According to the laser irradiation apparatus, the amount of air that hits the fin can be increased.

In the laser irradiation apparatus according to the one aspect, the irradiation target object may be a process target object to be processed with laser light from the laser element.

According to the laser irradiation apparatus, the irradiation target object can be processed accurately.

In the laser irradiation apparatus according to the one aspect, the irradiation target object may be a recording target object to be recorded with laser light from the laser element.

According to the laser irradiation apparatus, recording can be performed accurately on the irradiation target object.

In the laser irradiation apparatus according to the one aspect, the laser element may be a photonic crystal surface emitting laser.

According to the laser irradiation apparatus, a radiation angle of the laser light from the laser element can be narrowed.

What is claimed is:

1. A laser irradiation apparatus comprising:
a sub-mount including a first surface and a second surface opposite to the first surface;
a laser element being provided to the first surface of the sub-mount and configured to emit laser light;
a heat radiation unit being provided to the second surface of the sub-mount; and
a moving mechanism configured to change a relative position of the laser element and an irradiation target object.

2. The laser irradiation apparatus according to claim 1, wherein
the sub-mount has an insulating property.

3. The laser irradiation apparatus according to claim 1, wherein
the heat radiation unit has conductivity.

4. The laser irradiation apparatus according to claim 1, wherein
the moving mechanism includes two guide rails, and
the sub-mount is supported on the two guide rails.

5. The laser irradiation apparatus according to claim 4, wherein
the two guide rails do not overlap with the laser element in a plan view.

6. The laser irradiation apparatus according to claim 1, wherein
the heat radiation unit includes a plurality of fins.

7. The laser irradiation apparatus according to claim 6, wherein
the moving mechanism moves the laser element in a first direction, and
each of the plurality of fins extends in the first direction in a plan view.

8. The laser irradiation apparatus according to claim 6, wherein
the moving mechanism moves the laser element in a first direction, and
each of the plurality of fins extends in a second direction inclined with respect to the first direction in a plan view.

9. The laser irradiation apparatus according to claim 1, wherein
the irradiation target object is a process target object to be processed with the laser light from the laser element.

10. The laser irradiation apparatus according to claim 1, wherein
the irradiation target object is a recording target object to be recorded with the laser light from the laser element.

11. The laser irradiation apparatus according to claim 1, wherein
the laser element is a photonic crystal surface emitting laser.
